(19) United States
(12) Patent Application Publication
(10) Pub. No.: US 2022/0242636 A1
(43) Pub. Date: Aug. 4, 2022

(54) PAPERBOARD AND LAMINATE COMPRISING A BIO-BARRIER

(71) Applicant: Stora Enso OYJ, Helsinki (FI)

(72) Inventors: Susanne Hansson, Tyresö (SE); Raija Bådenlid, Karlstad (SE); Kaj Backfolk, Villmanstrand (SE)

(73) Assignee: Stora Enso OYJ, Helsinki (FI)

(21) Appl. No.: 17/597,218

(22) PCT Filed: Jun. 30, 2020
(86) PCT No.: PCT/IB2020/056159

§ 371 Date: Dec. 29, 2021

(30) Foreign Application Priority Data
Jul. 9, 2019 (SE) 1950872-0

(51) Int. Cl. B65D 65/42; B32B 29/00; B32B 29/06; D21H 11/18; D21H 27/30; C08L 1/02; C08L 5/14; C08L 29/04; D21H 21/16

(52) U.S. Cl. CPC B65D 65/42; B32B 2439/00; B32B 29/06; D21H 11/18; D21H 27/30; C08L 1/02; C08L 5/14; C08L 29/04; D21H 21/16; B32B 2255/12; B32B 2255/26; B32B 2250/03; B32B 2250/26; B32B 2307/7244; B32B 2307/718; B32B 29/005

(57) ABSTRACT

The present invention relates to a paper or paperboard substrate having barrier properties, which substrate comprises a single or multiply structure with e.g. a top ply, a middle ply and a bottom ply, wherein at least one of said top ply and said bottom ply is provided with a high-density bio-barrier layer, and wherein said top or bottom ply provided with the high-density bio-barrier layer and said top or bottom ply not provided with the high-density bio-barrier layer have both been subjected to grafting with a fatty acid halide.

### TECHNICAL FIELD

The present invention relates to a hydrophobized paper or paperboard substrate having barrier properties.

### BACKGROUND

Fiber based products used as packages must both be able to protect the packed product from outer influences as well as withstand the influence of the packed product. One way to achieve the desired protection is to provide the package with a barrier. Examples include liquid, oxygen, grease, aroma, and gas barriers. Barriers can be created by coating a fiber-based substrate with a composition which gives the substrate barrier properties. Different coatings can be applied depending on the needed properties of the barrier. The most commonly used materials when forming a barrier on a fiber-based product are polyethylene (PE), polypropylene (PP), polyethylene terephthalate (PET), ethylene vinyl alcohol (EVOH) or ethylene vinyl acetate (EVA). EVOH is normally used in order to create oxygen barriers and PE or PET is normally used in order to create a liquid and/or vapor barrier. The polymers are normally either laminated or extrusion coated to the fiber-based product. However, a polymer layer that gives the product barrier properties normally needs to be relatively thick and it is thus quite costly to produce such barrier, and there is also a strive to avoid fossil-based materials due to its negative environmental impact and to replace them with renewable solutions.

The most common way to approach reduction of oxygen transmission (OTR) through a paper or paperboard is to use multiple polymer layers. In this way, one layer can provide low OTR, whereas other layers can provide water repellency and/or low water vapor transmission rates. Another possibility is to add nanoparticles to barriers in order to create a so-called tortuosity effect.

There is a need to find a barrier solution that is free from fluorochemicals or wax, and which enables for reduced need for plastic coatings.

### SUMMARY OF THE INVENTION

It is an object of the present invention to solve or at least alleviate the problems presented above, and provide a paperboard material with barrier properties, which is free from fluorochemicals and wax, which is easier to recycle and enables for reduced use of fossil-based barrier coatings. The objects of the invention are at least partially obtained by means of a paper or paperboard substrate having barrier properties, according to claim 1, By “paper or paperboard” means cellulose fiber-based material typically produced on a wire from pulp slurry. The substrate according to the invention comprises a first surface and a second surface opposite to said first surface; wherein at least said first surface is provided with a bio-barrier layer having a density which is higher than the density of the paper or paperboard substrate; and wherein both of said first surface provided with the high-density bio-barrier layer and said second surface not provided with the high-density bio-barrier layer have been subjected to grafting with a fatty acid halide. In one aspect of the invention, said substrate comprises a plurality of plies, such as two or three plies, where at least one outer ply of the substrate is provided with a bio-barrier layer.

In the present application, the term “bio-barrier” refers to a barrier layer comprising at least 50 wt % of one or more renewable compound/s that has/have film-forming capacity, preferably at least 75 wt %, even more preferably at least 85 wt %. Further, the renewable compound/s preferably has/have a hydroxyl-group functionality. The bio-barrier in itself provides for good or moderate barrier properties for oxygen, fat and/or aroma, and these properties are improved or maintained also after grafting.

Examples of renewable, compound/s that have film-forming capacity include:

(i) cellulose nanomaterial such as microfibrillated cellulose (MFC);
(ii) cellulose derivative such as carboxymethylated cellulose (CMC), methyl ethyl hydroxyethyl cellulose (MEHEC), ethyl hydroxyethyl cellulose (EHEC), hydroxyethyl cellulose (HEC);
(iii) hemicelluloses such as xylans, glucans, glucomannan, e.g. guar gum;
(iv) monosaccharides such as xylose and pentose; and
(v) starch-based compounds.

The bio-barrier may also comprise a mixture of two or more of the above mentioned compounds.

Herein, the term “film forming capacity”, means that the compound can be used for forming a continuous layer having a density above 700 kg/m³ and an oxygen transmission rate (OTR) value below 500, preferably below 100, more preferably below 20 cc/m²/24 h/atm measured according to the standard ASTM F-1927 at 50% relative humidity and 23° C. Example of film forming compounds including polysaccharides is for instance (but not limited to) cellulose nanomaterials such as microfibrillated cellulose (MFC), which has many hydroxyl groups that can be readily utilized for grafting of fatty acid halides.

According to one aspect of the invention, said substrate comprises at least a top ply, a middle ply and a bottom ply, wherein at least one of said top ply and said bottom ply is provided with a high-density bio-barrier layer, and wherein said top or bottom ply provided with the high-density bio-barrier layer and said top or bottom ply not provided with the high-density bio-barrier layer have both been subjected to grafting with a fatty acid halide, and wherein the density of the bio-barrier is higher than the density of the top or bottom ply not provided with the high-density bio-barrier layer.

By means of grafting both sides of a substrate according to the invention both the side presenting the bio-barrier and the side which has lower density and preferably higher porosity and permeability the resulting material has been subjected to hydrophobizing treatment from two sides leading to a material with both hydrophobized bio-barrier and a hydrophobized core, fully or to a certain extent depending on the grammage and application method of the fatty acid halide.

By means of treating the substrate with fatty acid halides on both surfaces (i.e. both top and bottom surfaces), where one side has a dense bio-barrier facing away from the opposite side that has a higher permeability, there is achieved a higher penetration of the fatty acid halide into the depth of the substrate.

Grafting technology is used to hydrophobize cellulose-based substrates, and utilizes fatty acid halides (C16 or C18, preferably C16) in liquid, spray or gas phase to graft the available hydroxyl groups on said substrates, i.e. the fatty acids will be covalently attached to the fibers to a certain degree. There will also be free, unbound fatty acids, present in the final product because of the hydrolysis of the reagent that occurs in contact with water. The technology is applied on the surface of pre-made and dried papers/boards to limit the hydrolysis to occur. The moist content of the substrate should be below 20%, preferably below 15%, even more preferably below 10% WO2012066015A1 describes a machine that treats a moving substrate containing hydroxyl groups with a grafting reagent. A gas-phase process to graft fatty acid halides has also been described in WO2017002005A1, were vacuum is applied to draw the gas through the board to render the whole cellulose-based substrate treated with said fatty acid halide.

In the present application, the group of fatty acid halides preferably refers to fatty acid halides with an aliphatic chain length of 10-22 carbon atoms, such as lauroyl chloride (C12), Myristoyl chloride (C14), palmitoyl chloride (C16), stearoyl chloride (C18) or combinations thereof.

According to one aspect of the invention, the applied amount of fatty acid halide is between 0.1-4 g/m² of total dry weight of the substrate, preferably between 0.5-2 g/m². In order to analyze the amount of free and grafted fatty acids respectively in the treated substrate, a method based on the method for AKD analysis can be used. In this method, free fatty acids are extracted from the board sample with an organic solvent and analyzed with GC-FID after silylation. The same board sample is subsequently submitted to alkaline hydrolysis for breaking the ester bonds to cellulose and the released fatty acids are thereafter extracted and analyzed with GC-FID after silylation. The sum of the analyzed free and bound fatty acids constitutes the total amount of fatty acid halide.

A bio-barrier may contain up to 50 wt % of different grades of polyvinyl alcohol) (PVOH) and mixtures thereof, preferably below 25 wt %, more preferably below 15 wt %, Due to its high number of accessible hydroxyl groups, even smaller amounts below 15 wt % of PVOH added to the coating and base substrate can lead to increased fatty acid halide grafting. The PVOH may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 88-99 mol %. Furthermore, the PVOH may preferably have a viscosity above 5 mPa×s in a 4% aqueous solution at 20° C. DIN 53015/JIS K 6726.

The application of the bio-barrier onto the substrate is preferably performed on-line in the paper or paperboard machine, but it can also be performed as an off-line step. Furthermore, the dispersion coating may be added to the surface of the substrate by the aid of different techniques, such as blade, film press or curtain coating. Other coating techniques are also conceivable such as roller coating, spray coating, slot coating, immersion coating, gravure roll coating, reverse direct coating and/or combinations thereof. It may also be possible to use rod, size press, air blade metered size press, flexo coating, anilox applicator rolls or combinations thereof. The bio-barrier can also be added to the paper or paperboard as a pre-made film.

The term “cellulose nanomaterial” referred to herein is to be interpreted as materials comprising cellulose and encompasses micro/nanofibrillated cellulose (MFC/NFC) as well as cellulose nanocrystals (nanocrystalline cellulose) and mixtures thereof. This means that one dimension (the diameter) of the fibers is within the scale of 1-1000 nm (mean average fiber or fibril diameter). Microfibrillated cellulose (MFC) or so called cellulose microfibrils (CMF) shall in the context of the present invention mean a cellulose particle fiber or fibril with at least one average or mean dimension less than 1000 nm. MFC comprises partly or totally fibrillated cellulose or lignocellulose fibers. The cellulose fiber is preferably fibrillated to such an extent that the final specific surface area of the formed MFC is from about 1 to about 500 m²/g, such as from 10 to 400 m²/g or more preferably 50-300 m²/g when determined for a solvent exchanged and freeze-dried material with the BET method.

Various methods exist to make MFC, such as single or multiple pass refining, pre-treatment followed by refining, or high shear disintegration or liberation of fibrils. One or several pre-treatment steps are usually required in order to make MFC manufacturing both energy-efficient and sustainable. The cellulose fibers of the pulp to be supplied may thus be pre-treated enzymatically or chemically, for example to reduce the quantity of hemicellulose or lignin.

The microfibrillar cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, single- or twin-screw extruder, fluidizer such as microfluidizer, macrofluidizer or fluidizer-type homogenizer. Depending on the MFC manufacturing method, the product might also contain fines, or nanocrystalline cellulose or e.g. other chemicals present in wood fibers or other lignocellulosic fibers used in papermaking processes. The product might also contain various amounts of micron size fiber particles that have not been efficiently fibrillated. The amount of these fiber particles can be determined e.g. in fiber analyzer which is known for a skilled person in the art. MFC can be produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

According to one aspect of the invention, the density of the bio-barrier is above 700, preferably above 950 and even more preferably above 1050 kg/m³.

According to one aspect of the invention, the bio-barrier layer comprises a basis weight below 55 g/m², preferably in the range of 2-50 g/m², and even more preferably in the range of 5-35 g/m².

According to one aspect of the invention, the bio-barrier layer comprises a basis weight of at least 5 g/m² in order to provide a good barrier function, i.e. OTR below 500, preferably below 100, more preferably below 20 cc/m²/24 h/atm. The OTR of the bio-barrier layer will not change during grafting, i.e. the OTR of the paper or paperboard comprising the bio-barrier layer is the same before and after grafting.

According to one aspect of the invention, the bio-barrier layer comprises at least 50 wt % MFC and a basis weight of at least 5 g/m² in order to provide a good barrier function, (i.e. providing a barrier function of an OTR below 500, preferably below 100, more preferably below 20 cc/m²/24 h/atm).

According to one aspect of the invention, the bio-barrier comprises at least 50 wt % microfibrillated cellulose (MFC), said MFC having a Schopper-Riegler value in the range of 70-94, wherein the bio-barrier further comprises a basis weight in the range of 5-35 g/m².

According to the invention, the bio-barrier has an oxygen transmission rate (OTR) below 500, preferably below 100, and even more preferably below 20 cc/m²/24 h/atm, measured according to the standard ASTM F-1927 at 50% relative humidity and 23° C.

According to the invention, providing a bio-barrier layer having good oxygen barrier function (i.e. OTR below 500, preferably below 100, and even more preferably below 20 cc/m²/24 h/atm) and using herein described grafting technology for hydrophobizing the substrate will result in a material with good barrier properties against oxygen and grease as well as against aqueous liquids. MFC content in the bio-barrier contributes to a grease barrier function, as will a content of PVOH.

According to one aspect of the invention, the bio-barrier further comprises a filler such as inorganic particles of talcum, silicates, carbonates, alkaline earth metal carbonates and ammonium carbonate, or oxides, such as transition metal oxides and other metal oxides. The filler may also comprise nano-size pigments such as nanoclays and nanoparticles of layered mineral silicates, for instance selected from the group comprising montmorillonite, bentonite, kaolinite, hectorite and hallyosite.

According to one aspect of the invention, the paper or paperboard material comprises a basis weight in the range of 40-700 g/m², preferably in the range of 60-600 g/m².

According to yet another aspect of the invention, said paperboard has been subjected to grafting with a fatty acid chloride through the entire thickness of said paper or paperboard or to a certain penetration depth depending on the grammage and application method.

According to another aspect of the invention, after grafting of the surface of the paper or paperboard comprising the bio-barrier, the Cobbso value is below 30 g/m² (as determined according to standard ISO 535:2014 after 60 seconds), preferably below 20 g/m², and more preferably below 15 g/m².

According to yet another aspect of the invention, after grafting, the paper or paperboard comprising the bio-barrier has a KIT barrier in a range from 6-12, preferably in a range from 9-12. As used herein, the Kit Rating Number refers to a metric given to indicate how well a surface such as the surface of the dried coating of the coated paperboard resists penetration by a series of reagents of increasing aggressiveness (TAPPI method 559, 3M KIT test).

According to yet another aspect of the invention, after grafting of both surfaces of the paper or paperboard comprising the bio-barrier, the edge-wick index (Lactic acid 1% solution, 1 h at 23° C. and 50% relative humidity) is below 3 kg/m² h, preferably below 1.5 kg/m² h, and even more preferably below 1 kg/m² h.

According to yet another aspect of the invention, said substrate can comprise at least one polymer layer forming an outer surface of said substrate, wherein said polymer comprises any of the following; polyethylene (PE), polyethylene terephthalate (PET), polyvinyl alcohol (PVOH), polylactic acid (PLA), polyvinyl acetate (PVA), polypropylene (PP) and/or polyamide (PA). Thanks to the invention, it is possible to replace one or two polymer layers, especially the layer utilized for condensation.

Grafting a fatty acid chloride on a polymer pre-coating, such as PVOH pre-coating, leads to forming of water, water vapor and grease barrier. The added barrier properties of said grafted bio-barrier further leads to that a reduced amount of polymer layer is possible, while still obtaining the required barrier function.

According to yet another aspect of the invention, the repulpability of the grafted paper or paperboard substrate with the bio-barrier gives a reject of less than 30%, preferably less than 20%, and even more preferably less than 10%, according to recyclability test-method RH 021/97 (PTS).

The present invention also relates to a method for manufacturing a paper or paperboard having barrier properties, said method comprising at least the following steps:

a) providing a paper or paperboard substrate comprising a first surface and a second surface opposite to said first surface, wherein at least said first surface is provided with a bio-barrier layer having a density which is higher than the density of the paper or paperboard substrate at the second surface; and
b) subjecting both said first surface provided with the high-density bio-barrier layer and said second surface not provided with the high-density bio-barrier layer to grafting with a fatty acid halide.

According to yet another aspect of the invention, said paper or paperboard comprises fibers or a mix or fibers from soft wood, hard wood, Kraft pulp, sulphite pulp, dissolving pulp, chemical pulp, thermomechanical pulp (TMP), chemi-thermomechanical pulp (CTMP) or high-temperature (HT)-CTMP.

### BRIEF DESCRIPTION OF THE DRAWINGS

In the following, the invention will be described in more detail with reference to preferred embodiments and the appended drawings, wherein

FIG. 1 schematically illustrates two examples of producing a material according to the invention;

FIG. 2 shows a schematic view of the plies of a prior art multilayer paperboard material;

FIG. 3 shows a schematic view of an example of a multilayer paperboard according to the invention;

FIG. 4a shows a schematic view of another example of a multilayer paperboard according to the invention; and

FIG. 4b shows a schematic view of yet another example of a multilayer paperboard according to the invention.

### DETAILED DESCRIPTION OF THE INVENTION

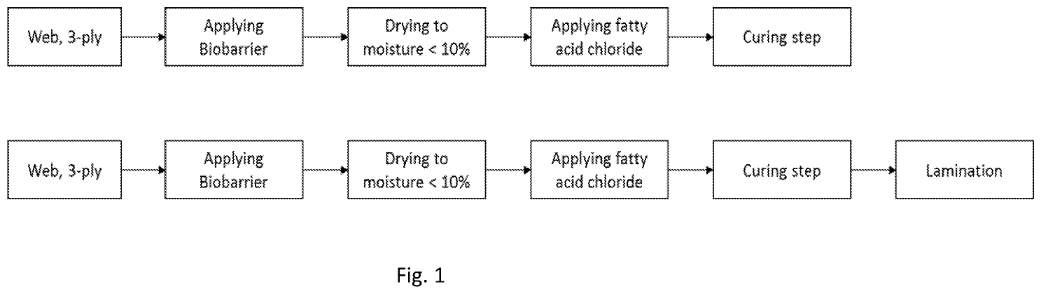

FIG. 1 is a schematic view of two exemplary, step-wise manufacturing processes for producing paperboard material with a bio-barrier according to the invention.

As illustrated in FIG. 1, a multiply paperboard substrate is provided here in the form of a 3-ply web. (Herein, “multiply” refers to multiple plies/a plurality of plies >2 plies). Next, a bio-based barrier is applied to one of the surfaces and dried to moisture <10%. Then, grafting is performed by applying a fatty acid chloride in at least one step to both surfaces (top ply and bottom ply) with a direct-contact or non-contact method, after which the product is cured by heat. As an option, the obtained grafted substrate can be used for further lamination.

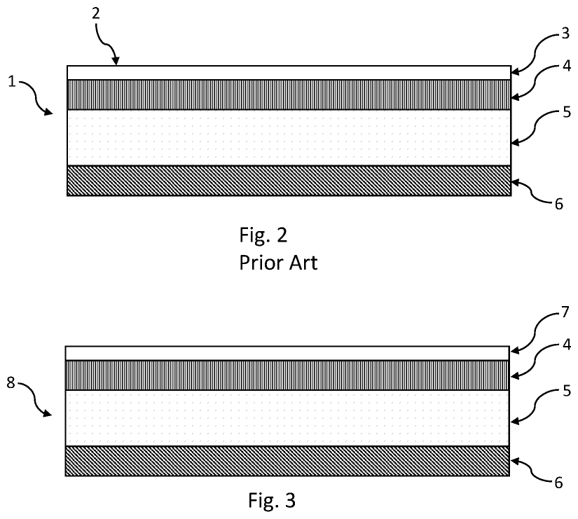

FIG. 2 illustrates an example of a multiply paperboard 1 in cross section according to prior art. Herein, a middle ply 5 corresponding to a bulking layer is attached to a porous top ply 4 and a bottom ply 6. All plies 4, 5, 6 are cellulose fiber-based layers. The top layer 4 has been subjected to treatment such as surface sizing, coating e.g. mineral coating etc. 3 for obtaining e.g. hydrophobic properties or a barrier function.

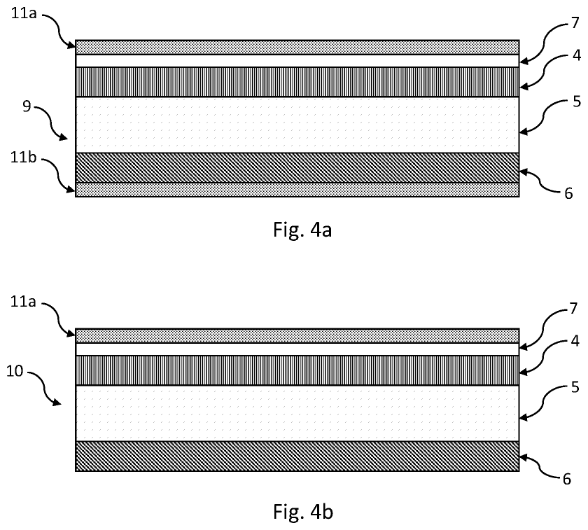

FIGS. 3, 4a and 4b illustrate three examples 8, 9, 10 of paperboard substrates according to the invention, all of which comprises a bio-barrier layer 7. Common for all of the three examples is that said substrate 8, 9, 10 comprises a middle ply 5 sandwiched between an attached top ply 4 and a porous bottom ply 6. A bio-barrier 7 is applied onto the top layer 4 of the substrate 8. Said bio-barrier 7 can be coated directly on the substrate as a dispersion or be added as a pre-made film. The bio-barrier 7 can be applied on a surface-sized board (a size-press can have applied starch on both sides). Grafting with fatty acid halide is performed by means of direct-contact or non-contact method to top ply 4 (coated with said bio-barrier 7) and bottom ply 6. The side 6 without the bio-barrier coating is more permeable than the coated barrier side, allowing for a higher penetration of the fatty acid chloride into the bulk of the board 8, 9, 10.

The substrates 9, 10 illustrated in FIGS. 4a-b differs from the one seen in FIG. 3 in that one or two surface/s are covered with a polymer layer 11a, 11b. In FIG. 4a, both the top and bottom sides of the paperboard substrate are covered with a polymer layer. The polymer layer may comprise any of the polymers commonly used in paper or paperboard based packaging materials in general or polymers used in liquid packaging board in particular. Examples include polyethylene (PE), polyethylene terephthalate (PET), polypropylene (PP) and polylactic acid (PLA). Polyethylenes, especially low density polyethylene (LOPE) and high density polyethylene (HDPE), are the most common and versatile polymers used in liquid packaging board. The basis weight (corresponding to the grammage) of the polymer layer of the inventive substrate is preferably in less than 50 gsm (grams per square meter). In order to achieve a continuous and substantially defect free film, a basis weight of the polymer layer of at least 8 gsm, preferably at least 12 gsm is typically required. In some embodiments, the basis weight of the polymer layer is in the range of 8-50 gsm, preferably in the range of 12-50 gsm. A multiply paperboard comprising outer polymer layers provides efficient barrier against gas, e.g. oxygen, and/or water as liquid or gas.

However, thanks to the grafting in combination with use of a bio-barrier according to the invention, the barrier properties of the paperboard can be improved to such a level that the need for plastic coatings can be significantly reduced in many applications. One example is showed in FIG. 3 where no plastic coating is applied. Another example is illustrated in FIG. 4b, wherein one polymer layer is removed leaving only the PE-layer on the side of the substrate 10 comprising the bio-barrier coating.

The basis weight (corresponding to the grammage) of the bio-barrier layer 7 is preferably in the range of less than 55 g/m². The basis weight of the bio-barrier layer 7 may for example depend on the mode of its manufacture. For example, coating of an MFC dispersion onto a substrate may result in a thinner layer, whereas the formation of a free standing MFC film for lamination to a substrate may require a thicker layer. In some embodiments, the basis weight of the MFC layer is in the range of 5-50 g/m². In some embodiments, the basis weight of the MFC layer is in the range of 5-20 g/m².

Moreover, grafting of the fatty acid halide to a bio-barrier layer surface can be achieved by applying a fatty acid halide to the surface of the layer and heating the surface to form covalent bonds between the fatty acid residue and hydroxyl groups of the layer. The reaction between the fatty acid halide; e.g. fatty acid chloride, and the hydroxyl groups of the bio-barrier layer results in ester bonds between the reagent and the polysaccharides. Ungrafted and thereby unbound fatty acids may also be present to a certain extent. Upon the reaction with the hydroxyl groups on the substrate or with water in the substrate or in the air, hydrochloric acid (HCl) is formed as a reaction byproduct. The grafting may preferably be followed by removal of the formed HCl, and optionally by removal of the ungrafted residues.

One example of a grafting process which could be used in production of the gas barrier film of the present disclosure is described in detail in WO2012066015A1.

In some non-limiting embodiments, the paper or paperboard based packaging material has the following general structures:
Grafting+Paper/Paperboard+Bio-barrier+Grafting
Grafting+Paper/Paperboard+Bio-barrier+Grafting+Polymer
Polymer+Grafting+Paper/Paperboard+Bio-barrier+Grafting
Polymer+Grafting+Paper/Paperboard+Biobarrier+Grafting+Polymer
The thickness of the outermost PE layer/s, is selected depending on if the layer is intended to form an outside or inside surface of a container manufactured for the packaging material. For example, an inside surface for a liquid packaging container may require a thicker PE layer to serve as a liquid barrier, whereas the outside surface a thinner PE layer or no PE layer may be sufficient.
The material according to the invention is suitable for use in a vast number of applications. A non-limiting list of examples include:
   structures utilized for liquid packaging boards (LPB) for use in the packaging of liquids or liquid-containing products, as well as paper or paperboard for dry, fat, fresh and/or frozen food, and laminates thereof;
   cup material and laminates thereof for hot and cold food stuff;
   general packaging, luxury packaging, and graphical board for their designated applications;
   products for non-food applications, such as flora and fauna products, pharma products, beauty and personal care products and multi-pack products;
   well and wrapping paper (food and non-food based);
   pouches;
   paper or paperboard for single-use items;
   labels, grease-proof paper, high-density paper, sack paper and well structures.

While the invention has been described with reference to various exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A paper or paperboard substrate having barrier properties, said substrate comprising:
a first surface and a second surface opposite to said first surface;
wherein at least said first surface is provided with a bio-barrier layer comprising at least 50 wt % of one or more renewable compounds having a film-forming capacity, and having a density which is higher than a density of the paper or paperboard substrate at the second surface;
wherein both of said first surface provided with the bio-barrier layer and said second surface have been subjected to grafting with a fatty acid halide; and
wherein the paper or paperboard substrate has an oxygen transmission rate below 500 cc/m²/24 h/atm, measured according to the standard ASTM F-1927 at 50% relative humidity and 23° C.

2. The paper or paperboard substrate according to claim 1, where said substrate comprises:
a top ply, a middle ply and a bottom ply,
wherein at least one of said top ply and said bottom ply is provided with the bio-barrier layer, and wherein said top or bottom ply provided with the bio-barrier layer and said top or bottom ply not provided with the bio-barrier layer have both been subjected to grafting with a fatty acid halide, and wherein the density of the bio-barrier layer is higher than the density of the top or bottom ply not provided with the bio-barrier layer.

3. The paper or paperboard substrate according to claim 1, wherein said one or more renewable compounds is selected from one or more of the following:
(i) cellulose nanomaterial;
(ii) cellulose derivative;
(iii) hemicelluloses;
(iv) monosaccharides; and
(v) starch-based compounds.

4. The paper or paperboard substrate according to claim 3, wherein the bio-barrier layer comprises at least 50 wt % of the one or more renewable compounds.

5. The paper or paperboard substrate according to claim 1, wherein the density of the bio-barrier is above 700 kg/m³.

6. The paper or paperboard substrate according to claim 1, wherein the bio-barrier layer comprises a basis weight in a range of 2 to 55 g/m².

7. The paper or paperboard substrate according to claim 1, wherein said bio-barrier layer comprises at least 50 wt % microfibrillated cellulose (MFC), said MFC having a Schopper-Riegler value in a range of 70-94, and wherein the bio-barrier layer further comprises a basis weight in a range of 5- to 35 g/m².

8. The paper or paperboard substrate according to claim 3, wherein the bio-barrier layer comprises at most 50 wt % of different grades of poly(vinyl alcohol) (PVOH) and mixtures thereof.

9. The paper or paperboard substrate according to claim 1, wherein the bio-barrier layer, prior to grafting, has an oxygen transmission rate (OTR) below 500 cc/m²/24 h/atm measured according to the standard ASTM F-1927 at 50% relative humidity and 23° C.

10. The paper or paperboard substrate according to claim 1, wherein the fatty acid halide grafting results in a material having a Cobb60 value below 30 g/m² (as determined according to standard ISO 535:2014 after 60 seconds).

11. The paper or paperboard substrate according to claim 1, wherein said substrate further comprises:
at least one outer polymer layer forming an outer surface of said substrate,
wherein said polymer comprises: polyethylene (PE), polyethylene terephthalate (PET), polyvinyl alcohol (PVOH), polylactic acid (PLA), polyvinyl acetate (PVA), polypropylene (PP), and/of polyamide (PA) or mixtures thereof.

12. A method for manufacturing a paper or paperboard substrate having barrier properties, said method comprising:
a) providing a paper or paperboard substrate comprising a First surface and a second surface opposite to said first surface, wherein at least said first surface is provided with a bio-barrier layer having a density which is higher than a density of the paper or paperboard substrate at the second surface; and
b) subjecting both said first surface provided with the bio-barrier layer and said second surface to grafting with a fatty acid halide.

13. The method according to claim 12, wherein said paper or paperboard substrate comprises a top ply, a middle ply and a bottom ply,
wherein one of said top ply and said bottom ply is provided with the bio-barrier layer, and wherein both of said top ply and said bottom ply are subjected to grafting with a fatty acid chloride.

14. The method according to claim 12, wherein the fatty acid halide comprises an aliphatic chain length of 10-22 carbon atoms.

15. The method according to claim 12, wherein an applied amount of fatty acid halide is between 0.1-4 g/m² of a total dry weight of the substrate.

16. A product produced from the paper or paperboard substrate according to claim 1, wherein the product is selected from a group consisting of:
structures utilized for liquid packaging boards (LPB) for use in the packaging of liquids or liquid-containing products, paper or paperboard for dry, fat, fresh and/or frozen food, and laminates thereof;
cup material and laminates thereof for hot and cold food stuff;
general packaging, luxury packaging, and graphical board for their designated applications;
products for non-food applications;
well and wrapping paper;
pouches;
paper or paperboard for single-use items; and
labels, grease-proof paper, high-density paper, sack paper and well structures.
